(19) United States
(12) Patent Application Publication
(10) Pub. No.: US 2026/0328254 A1
(43) Pub. Date: Oct. 22, 2026

(54) BRAKE ASSEMBLY INCLUDING A SHAFT AND A BRAKE-LINING CARRIER

(71) Applicant: SEW-EURODRIVE GMBH & CO. KG, Bruchsal (DE)

(72) Inventors: Gerolf FICHTNER-PFLAUM, Kraichtal-Unteröwisheim (DE); Robert STRAATMAN, Graben-Neudorf (DE)

(73) Assignee: SEW-EURODRIVE GMBH & CO. KG, Bruchsal (DE)

(21) Appl. No.: 18/997,904

(22) PCT Filed: Jun. 26, 2023
(86) PCT No.: PCT/EP2023/067354

§ 371 Date: Jan. 23, 2025

(30) Foreign Application Priority Data
Jul. 26, 2022 (DE) 10 2022 002 714.3

(51) Int. Cl. F16D 65/12; F16D 55/02; F16D 59/00; F16D 65/02; F16D 65/18; F16D 121/22; H02K 7/102

(52) U.S. Cl. CPC F16D 65/123; F16D 55/02; F16D 59/00; F16D 65/18; H02K 7/102; F16D 2065/1368; F16D 2065/1388; F16D 2121/22

(57) ABSTRACT

A brake assembly includes a shaft and brake-lining carrier. An annular driver is connected to the shaft for conjoint rotation, the brake-lining carrier has an inner toothing which is in engagement with an outer toothing of the driver, and a spring part is resiliently clamped in an annular groove. The spring force generated by the spring part supported against the driver has a first force component which presses against the brake-lining carrier in a radial direction, and has a second force component which is directed in an axial direction and acts upon the brake-lining carrier.

### FIELD OF THE INVENTION

The present invention relates to a brake assembly that includes a shaft and brake-lining carrier.

### BACKGROUND INFORMATION

In certain conventional systems, a shaft can be braked by a friction brake.

A brake assembly with a shaft-hub connection is described in German Patent Document No. 10 2022 001 345.

A tooth clutch with a spring is described in German Patent Document No. 10 2011 121 790.

A centering device for gear drives is described in German Patent Document No. 78 25 113.

A shaft-hub connection with an anti-rattle device is described in U.S. Pat. No. 2,800,800.

### SUMMARY

Example embodiments of the present invention provide a brake, in which a most dynamic and/or safe operation possible may be achieved.

According to example embodiments, a brake assembly includes a shaft and brake-lining carrier, in which an annular driver is connected to the shaft for conjoint rotation, e.g., in a form-locking manner, e.g., via of a feather key connection. For example, the brake-lining carrier is fitted onto the driver. The brake-lining carrier has an inner toothing which is in engagement with an outer toothing of the driver, e. g., so that the brake-lining carrier is arranged to be displaceable relative to the driver in the axial direction, e.g., parallel to the direction of the axis of rotation of the shaft. A spring part is accommodated and/or resiliently clamped in an annular groove, e.g., an annular inner groove. The spring force generated by the spring part supported against the driver has a first force component which presses against the brake-lining carrier in a radial direction, and has a second force component which is directed in an axial direction and acts upon the brake-lining carrier.

Thus, an axial restoring force is provided by the spring part, which pulls the brake-lining carrier back from a friction surface when no other forces are acting. For example, when current is applied to a winding of an electromagnetically actuated brake, which has the brake-lining carrier, an armature disk is pulled towards the magnet body, e.g., against the spring force generated by spring parts supported on the magnet body and pressing on the armature disk. This means that the brake-lining carrier does not have to freewheel automatically, but is actively pulled back, i.e., removed from the friction surface, via the axial force component provided by the spring part in the axial direction and applied to the brake-lining carrier-both when the shaft is rotating and when the shaft is stationary.

According to example embodiments, the restoring force is generated by resilient bending of the spring part. For example, the spring part has axial bends and can thus be deflected resiliently in the axial direction or the spring part is clamped in an annular groove and is carried along by the brake-lining carrier in the axial direction and is thus deflected resiliently.

The restoring force improves, e.g., accelerates and/or secures, the separating of the brake-lining carrier from the friction surface as soon as the winding is supplied with current and the armature disk is thus pulled towards the magnet body.

According to example embodiments, the brake-lining carrier has a ring part which has the inner toothing and to which at least one support disk is attached, to which respectively a friction lining is fitted. For example, the smallest radial distance of the ring part is radially spaced and arranged radially within the radial distance range covered by the supporting disks. Thus, the spring part generates a radially directed force between the ring part and the driver, so that the ring part carries along the spring part when the brake-lining carrier moves axially and thus resiliently preloads the spring part axially.

According to example embodiments, the ring part has the annular groove, e.g., the annular inner groove. For example, the annular groove is arranged axially next to the inner toothing. Thus, the restoring force can be applied as close as possible to the friction surface and thus a stable mode of operation can be achieved.

According to example embodiments, the spring part is produced from a round wire as a bent part. Thus, ready, cost-effective production is possible. The round wire is also bendable in a defined and simple manner.

According to example embodiments, the spring part has radially directed bends, e.g., five bends. Thus, the bends are readily and inexpensively able to be produced.

According to example embodiments, the spring part is shaped in a rising spiral form in the axial direction, e.g., with the disappearance of the second axial force component. Thus, the spring part is helically shaped so that the spring part rises axially monotonically, e.g., strictly monotonically, with increasing screw angle, i.e., circumferential angle around the axis of rotation of the shaft. This applies, for example, if the brake-lining carrier is not pressed against the friction surface and the spring part is thus untensioned in the axial direction, i.e., the brake-lining carrier is arranged free of the friction surface and the armature disk.

In this manner, the spring part clamps or tensions itself in the groove bottom of the annular groove without play even if the annular groove at the groove bottom has a larger groove width than the diameter of the round wire of the spring part.

According to example embodiments, the spring part is shaped to rise monotonically, e.g., strictly monotonically, with increasing circumferential angle in the axial direction, e.g., with the disappearance of the second axial force component. Thus, the spring part is helically shaped so that the spring part rises axially monotonically, e.g., strictly monotonically, with increasing screw angle, i.e., circumferential angle around the axis of rotation of the shaft. This applies, for example, if the brake-lining carrier is not pressed against the friction surface and the spring part is thus untensioned in the axial direction, i.e., the brake-lining carrier is arranged free of the friction surface and the armature disk.

In this manner, the spring part clamps or tensions itself in the groove bottom of the annular groove without play even if the annular groove at the groove bottom has a larger groove width than the diameter of the round wire of the spring part.

According to example embodiments, the spring part has axial bends, e.g., one or two bends. Thus, the bends are readily and inexpensively able to be produced.

According to example embodiments, the circumferential angle range covered by the spring part in the circumferential direction extends over less than 270°, e.g., it extends over more than 180°. Thus, the spring part applies a radially directed force and is arranged and supported in a stable manner.

According to example embodiments, the driver has one or the annular groove, e.g., which interrupts the outer toothing in the axial direction and/or which is arranged within the range covered by the outer toothing in the axial direction. Thus, the spring part is supported both in the driver and in the ring part of the brake-lining carrier and a force is generated by the spring part in the radial direction so that the brake-lining carrier is pushed away from the driver in this radial direction.

According to example embodiments, the ring axis is oriented coaxially to the axis of rotation of the shaft. Thus, the driver, the outer toothing, the inner toothing, and/or the ring part of the brake-lining carrier are arranged coaxially to each other.

According to example embodiments, the groove width of the annular groove measured in the axial direction decreases monotonically with increasing groove depth. Thus, the groove becomes narrower as the radial distance decreases, which means that the round wire of the spring part jams at one point when the spring part is inserted.

According to example embodiments, at least one of the groove walls of the annular groove is beveled by an angle of 20° to 40°. Thus, the spring part jams when a critical depth value is reached during insertion.

According to example embodiments, at each circumferential angle position, the normal vector of at least one of the groove walls of the annular groove has an angular amount between 50° and 70° to the radial direction, e.g., to the radial direction belonging to the respective circumferential angle position. Thus, when the spring part is inserted, the spring part clamps itself with a section of its round wire when a critical groove depth is reached, so that the remaining spring part can be deflected resiliently with respect to the clamped part.

According to example embodiments, at least one of the groove walls of the annular groove has a circular section. Thus, ready production is possible, and jamming of the spring part at a well-defined groove depth can be achieved.

According to example embodiments, the shaft is rotatably mounted relative to a magnetic body, e.g., one made of ferromagnetic material, a winding suppliable with electric current is accommodated in an annular recess in the magnetic body, an armature disk made, e.g., of ferromagnetic material is arranged axially between the magnet body and the brake-lining carrier, and the armature disk is connected to the magnet body for conjoint rotation. For example, bolts attached to the magnet body protrude through recesses in the armature disk. The brake-lining carrier is axially arranged between the armature disk and a friction surface. For example, the friction surface is formed on a plate or bearing flange connected to the magnet body for conjoint rotation and in a detachable manner, and spring elements supported on the magnet body, e.g., annular springs, press onto the armature disk, e.g., so that when the winding is supplied with current, the armature disk is pulled towards the magnet body against the spring force generated by the spring elements and the brake-lining carrier is moved away from the friction surface via the second force component and so that when the winding is not supplied with current, the spring elements press the armature disk towards the brake-lining carrier, thus pressing the brake-lining carrier, e.g., with one of its friction linings, against the friction surface.

Thus, the brake is applied automatically in the event of a power failure, since the spring elements then press the armature disk against the brake-lining carrier and thus press the brake-lining carrier, on its side facing away from the armature disk, against the friction surface. When no current is applied, the brake-lining carrier detaches from the friction surface, as the spring part generates an axially directed restoring force that pulls the brake-lining carrier back from the friction surface.

According to example embodiments, the diameter of the round wire of the spring part is larger than the smallest groove width of the annular groove measured in the axial direction, e.g., so that the round wire is pressed into the annular groove. Thus, the spring part jams in a defined position when it is pressed into the annular groove.

According to example embodiments, the shaft is the rotor shaft of the electric motor. Thus, the rotor shaft of the electric motor can be braked. The stator of the electric motor is connected for conjoint rotation to the friction surface and the magnet body.

Further features and aspects of example embodiments of the present invention are explained in more detail below with reference to the appended schematic Figures.

### BRIEF DESCRIPTION OF THE DRAWINGS

FIG. 1 is a longitudinal cross-sectional view through a brake-lining carrier of an electromagnetically actuated brake.

FIG. 2 is an enlarged view of a region of FIG. 1, in which a preloaded spring part 20 arranged in an annular inner groove, e.g., pressing radially outwards, is illustrated.

FIG. 3 is a top view of the brake-lining carrier.

FIG. 4 is a perspective view of the driver 30.

FIG. 5 is a cross-sectional view through the driver 30.

FIG. 6 is a top view of the spring part 20 illustrating the radially directed bends of the spring part 20.

FIG. 7 is a side view of the driver 30.

FIG. 8 is a side view of the spring part 20, illustrating axially directed bends of the spring part 20.

FIG. 9 is a longitudinal cross-sectional view through the driver 30 of a second electromagnetically actuated brake.

FIG. 10 is an enlarged view of an annular groove 100 of the driver 30 illustrated in FIG. 9.

FIG. 11 illustrates an annular groove 110 as an alternative to that illustrated in FIGS. 9 and 10.

FIG. 12 is a side view of the spring part 20, in which the spring part 20, in contrast to that illustrated in FIG. 8, has a spiral-shaped pitch, e.g., an axial pitch that increases monotonically, e.g., strictly monotonically, with increasing circumferential angle.

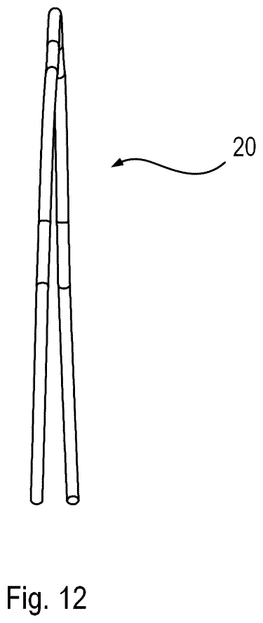

### DETAILED DESCRIPTION

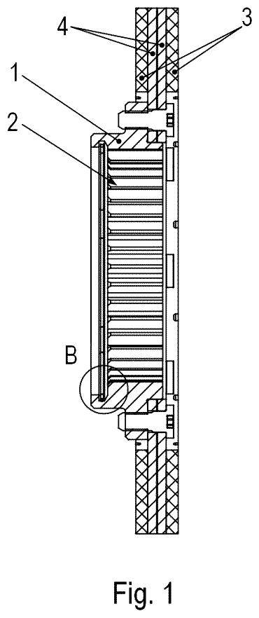

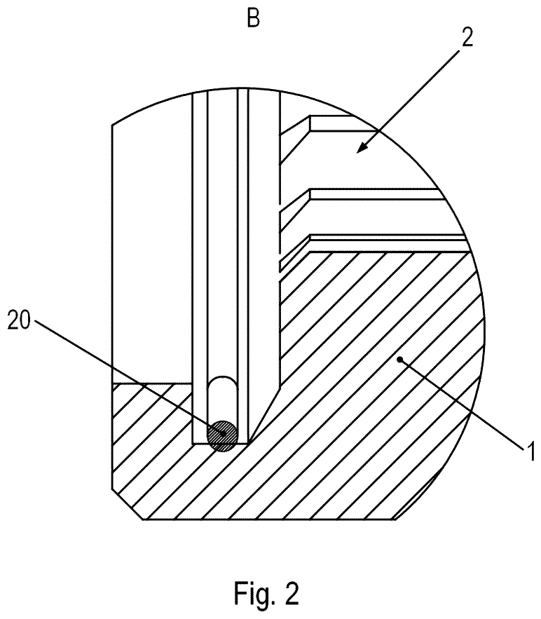

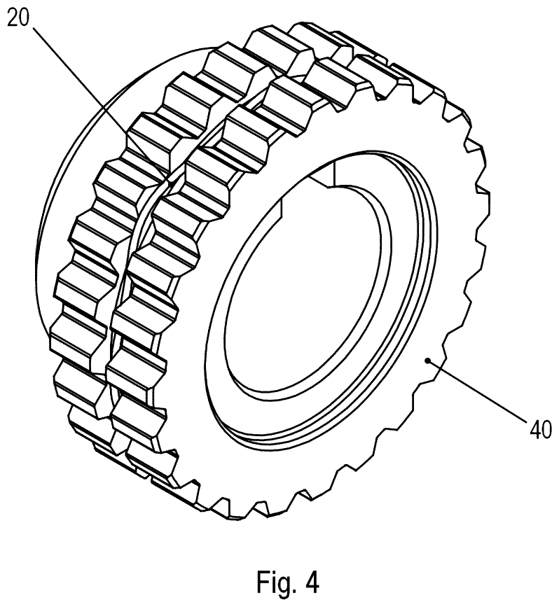

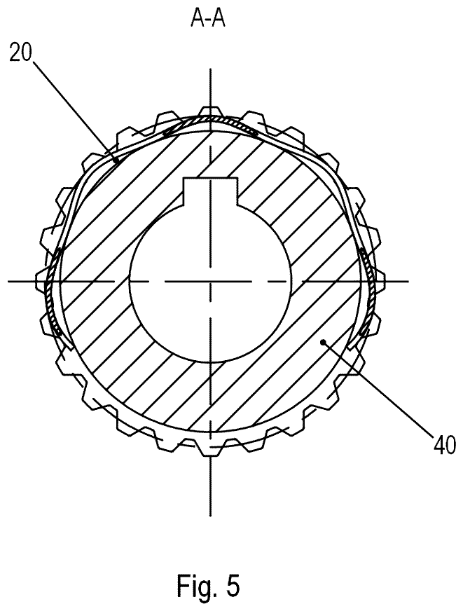

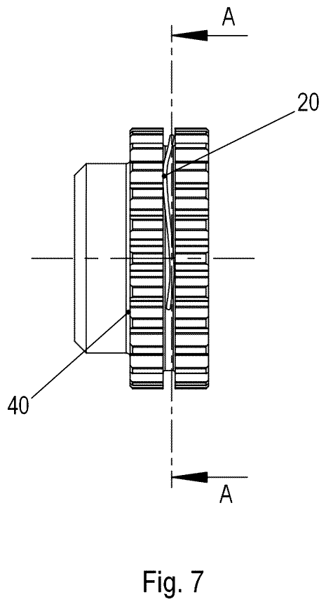

As illustrated in FIGS. 1 to 8, the brake-lining carrier has a ring part 1 with an inner toothing 2. Two support disks 4, e.g., two perforated support disks 4, are provided with a friction lining 3 on the axial end face facing away from the respective other support disk.

On the support disks 4 not provided with friction lining 3, the two support disks 4 are arranged in contact with and lying against each other. The support disks are connected to the ring part 1 via axially aligned screws. For this purpose, the screws are screwed into axially aligned threaded holes, and the screw heads of the screws press a first of the support disks 4 against the other support disk 4 so that these are pressed against the ring part 1.

Axially next to the inner toothing 2, an annular internal groove, e.g., an annular groove, is formed on the ring part 1, in which annular groove the spring part 20 is accommodated. This ring part 20 is, for example, resiliently preloaded and thus presses radially outwards.

The support disks 3 are aligned coaxially to each other and also to the ring part 1.

For example, the ring part 20 can be designated as spring ring, and the spring ring is interrupted in the circumferential direction.

The ring part 20, for example, includes or consists of a bent round wire.

The ring part 20 has radially directed bends so that the ring part 20 presses radially outwards against the ring part 1 via the first bends, e.g., against the groove bottom of the annular inner groove of the ring part 1. Second bends are directed radially inwards.

The brake-lining carrier is fitted onto an annular driver 40 with external toothing, which is connected to a shaft for conjoint rotation, e.g., via a feather key connection. The inner toothing 2 is fitted onto the outer toothing of the driver.

For example, the outer toothing of the driver 40 is in engagement with the inner toothing 2 of the brake-lining carrier, e.g., of the ring part 1. The driver 40 is thus connected to the ring part 1 for conjoint rotation.

The outer toothing and the inner toothing are arranged coaxially to each other.

The brake-lining carrier is arranged on the driver 40 to be displaceable in an axial direction.

The brake has a magnetic body, and a winding suppliable with current is accommodated in an annular recess of the magnetic body, e.g., the ring axis or winding axis is aligned parallel to the axial direction.

An armature disk, e.g., a disk made of a ferromagnetic material, is connected to the magnet body for conjoint rotation and arranged to be displaceable axially. For example, bolts are connected to the magnet body for this purpose, which protrude through recesses in the armature disk, e.g., such that the armature disk can be moved in an axial direction and is nevertheless connected to the armature disk for conjoint rotation.

The armature disk is arranged axially between the brake-lining carrier and the magnet body. The brake-lining carrier is arranged axially between the armature disk and a friction surface, which is provided either via a friction plate or via a corresponding finely machined flange part, e.g., an electric motor.

Spring elements supported on the magnet body, e.g., compression springs, press onto the armature disk, e.g., so that when the winding is not supplied with current, the armature disk is pressed away from the magnet body towards the brake-lining carrier, so that the brake-lining carrier is pressed onto the friction surface on its side axially facing away from the armature disk.

However, when the winding is supplied with current, the armature disk is pulled towards the magnet body against the spring force generated by the spring elements, thus releasing the brake-lining carrier. However, in order to support and/or safely ensure the release of the brake-lining carrier from the friction surface, a resilient deflection of the spring part 20 acts as a restoring force for the brake-lining carrier. This is because the spring part 20 is arranged resiliently preloaded between the ring part 1 and the driver 40 and, when the brake-lining carrier moves towards the friction surface, is axially carried along by the ring part 1 and is thus resiliently deflected.

Furthermore, the annular inner groove has a groove bottom whose width exceeds the diameter of the round wire of the spring part 20.

However, since the spring part not only has radial bends, but also axial bends, the spring part 20 is resiliently clamped at the groove bottom. For example, the spring part 20 is fixed at the groove bottom, so to speak.

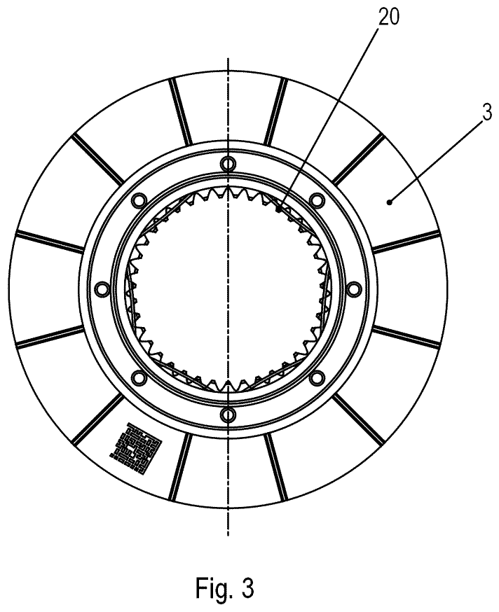

As illustrated in FIG. 3, the spring part 20 projects radially inwards from the annular inner groove of the ring part 1 in some circumferential angular regions, so that when the driver 40 is inserted in the axial direction, these radially inwardly projecting regions are pulled along somewhat in the axial direction and thus the spring part 20 is axially preloaded. In addition, radial preloading of the spring part 20 is achieved by radially displacing the spring part 1 when the outer toothing of the driver 40 is inserted into the inner toothing of the ring part 1.

For example, the outer toothing of the driver 40 has a chamfer at its end face end region, e.g., such that the largest external diameter of the outer toothing of the driver 40 increases monotonically in the axial direction, e.g., with increasing distance from the end face of the driver 40.

As illustrated in FIG. 3, the friction lining 3 is composed of pieces, e.g., twelve pieces, which are evenly spaced from one another in the circumferential direction and/or are all arranged at the same radial distance. Alternatively, the friction lining 3 is arranged in one piece, i.e., in one part.

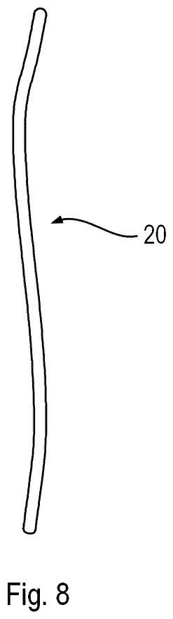

As illustrated in FIG. 8, the axial bends are configured such that the spring part 20 is sinusoidal in side view, i.e., for example, the vertical projection of the spring part 20 in a plane which has a radial direction and the axial direction as Cartesian coordinate axes is sinusoidal and/or resembles a sinusoidal arc.

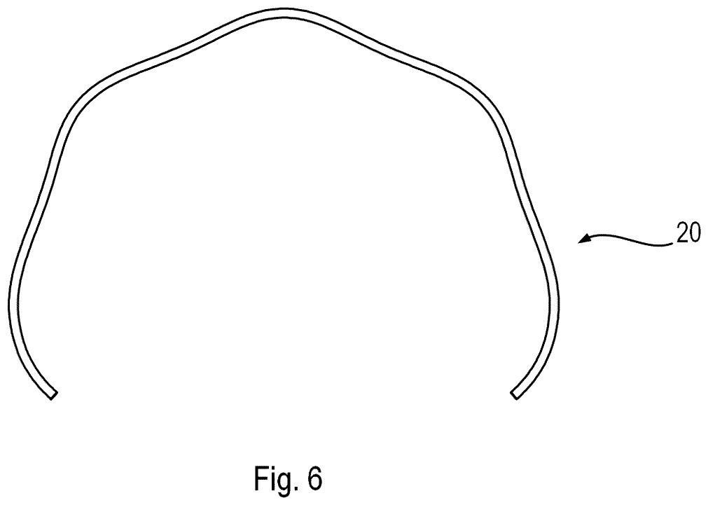

As illustrated in FIG. 6, the spring part has radial bends. For example, there are five bends, and these extend over a circumferential angle range of more than 180°, but, for example, less than 270°.

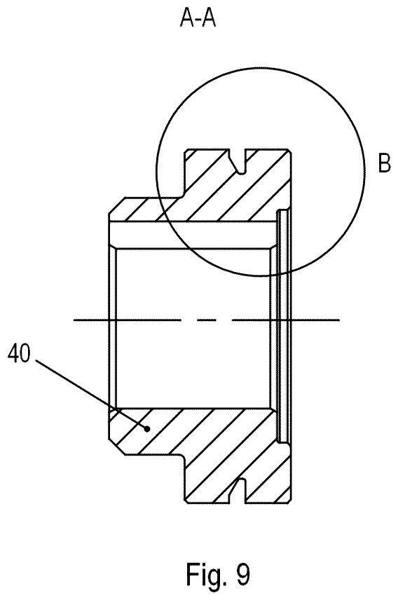

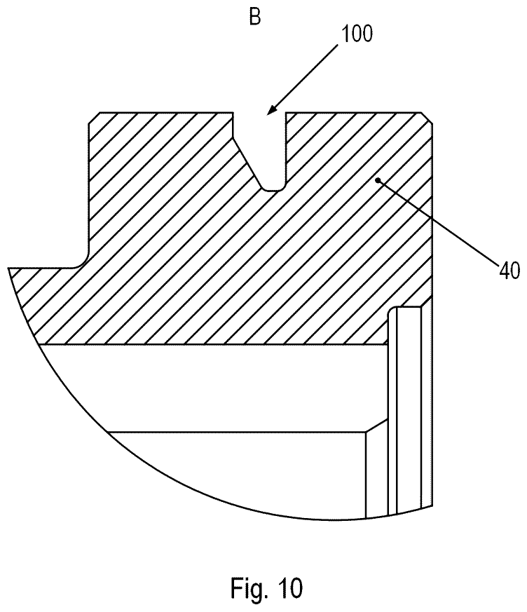

As illustrated in FIGS. 9 and 10, in contrast to the driver 40 of the first brake, the driver 40 of the second brake has a beveled groove wall at an annular groove 100 of the driver 40, which annular groove 100 is arranged in the region covered by the outer toothing of the driver 40 in the axial direction and in which the spring part 20 is resiliently clamped.

The spring part 20 is thus resiliently preloaded radially inwards. For example, the spring part 20 thus clamps in the annular groove of the driver 20.

The annular axis of the annular groove 100 is coaxially aligned with the axis of rotation of the brake-lining carrier and/or the shaft to be braked, onto which the driver is fitted and to which the driver is connected in a form-locking manner, e.g., via a feather key connection.

The annular groove is so narrow at the groove bottom that the spring part 20 has no or no significant play.

The annular inner groove on the ring part 1 of the brake-lining carrier may be omitted.

The groove wall of the groove 100 is inclined at an angle of preferably 30° or 20° to 40° to a plane whose normal direction is parallel to the axial direction.

For example, however, both groove walls can also be beveled, in which case the amount of the bevel angle is the same for both groove walls.

When the driver 40 is inserted into the ring part 1, the spring part 20 is thus, for example, deflected by the helix angle, thus providing a corresponding restoring force for the brake-lining carrier.

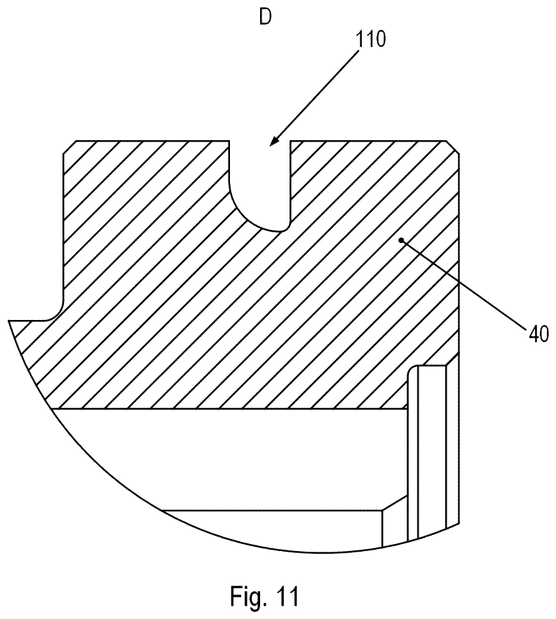

However, instead of the straight configuration of the groove wall in the longitudinal section, a curved configuration, as illustrated in FIG. 11, is also possible. In this case, for example, the groove wall has a circular section in the longitudinal section. For example, the two groove walls are symmetrical to each other.

For example, differently curved groove walls can also be used.

For example, instead of numbers of teeth of the toothing, e.g., inner toothing and outer toothing, of more than ten, numbers of teeth of ten or less, i.e., from one to ten, can also be used. The toothing can be arranged as involute toothing or as hypotrochoid toothing.

### LIST OF REFERENCE NUMERALS

1 Ring part
2 Inner toothing
3 Friction lining
4 Support disk
20 Spring part
40 Driver

1-15. (canceled)

16. A brake assembly, comprising:
a shaft;
an annular driver connected to the shaft for conjoint rotation and including an outer toothing;
a brake-lining carrier having an inner toothing in engagement with the other toothing of the driver; and
a spring part accommodated and/or resiliently clamped in an annular groove and is supported against the driver;
wherein the spring part is adapted to generate a spring force having a first force component that presses against the brake-lining carrier in a radial direction, and having a second force component directed in an axial direction and acting upon the brake-lining carrier.

17. The brake assembly according to claim 16, wherein the driver is connected to the shaft for conjoint rotation in a form-fitting manner by a feature-key connection, and the brake-lining carrier is arranged on the driver.

18. The brake assembly according to claim 16, wherein the inner toothing of the brake-lining carrier is in engagement with play and/or displaceable in the axial direction with the outer toothing of the driver, and/or the brake-lining carrier is displaceable relative to the driver in the axial direction and/or in parallel to a direction of an axis of rotation of the shaft.

19. The brake assembly according to claim 16, wherein the spring part is arranged as a spring ring and/or is arranged as a spring part including a bent round wire, and the annular groove is arranged as an annular inner groove.

20. The brake assembly according to claim 16, wherein the brake-lining carrier including a ring part having the inner toothing and to which at least one support disk is attached, to which a friction lining is fitted.

21. The brake assembly according to claim 20, wherein a smallest radial distance of the ring part is radially spaced and arranged radially within a radial distance range covered by the supporting disk.

22. The brake assembly according to claim 20, wherein the ring part includes the annular groove.

23. The brake assembly according to claim 22, wherein the annular groove is arranged axially next to the inner toothing.

24. The brake assembly according to claim 16, wherein the spring part has radially directed bends and/or five radially directed bends.

25. The brake assembly according to claim 16, wherein the spring part is shaped in a rising spiral form in the axial direction and/or is shaped rising monotonically and/or strictly monotonically with an increasing circumferential angle in the axial direction.

26. The brake assembly according to claim 16, wherein the spring part includes one axial bend, two axial bends, or a plurality of axial bends.

27. The brake assembly according to claim 16, wherein e circumferential angle range covered by the spring part in a circumferential direction extends over less than 270° and/or between 180° and 270°.

28. The brake assembly according to claim 18, wherein the driver includes the annular groove and the annular groove interrupts the outer toothing in the axial direction and/or is arranged within a range covered by the outer toothing in the axial direction.

29. The brake assembly according to claim 19, wherein a ring axis is oriented coaxially to an axis of rotation of the shaft.

30. The brake assembly according to claim 16, wherein a groove width of the annular groove measured in the axial direction decreases monotonically with increasing groove depth.

31. The brake assembly according to claim 16, wherein at least one groove wall of the annular groove is beveled by an angle of 20° to 40°, and/or at each circumferential angle position, a normal vector of at least one groove wall of the annular groove has an angular amount between 50° and 70° to the radial direction.

32. The brake assembly according to claim 16, wherein at least one groove wall of the annular groove has a circular section.

33. The brake assembly according to claim 16, wherein the shaft is rotatably mounted relative to a magnetic body, a winding suppliable with electric current is accommodated in an annular recess in the magnetic body, an armature disk and/or a ferromagnetic armature body is arranged axially between the magnet body and the brake-lining carrier, the armature disk is connected to the magnet body for conjoint rotation, spring elements supported on the magnet body press onto the armature disk, and the brake-lining carrier is axially arranged between the armature disk and a friction surface.

34. The brake assembly according to claim 33, wherein the friction surface is arranged on a plate and/or a bearing flange connected to the magnet body for conjoint rotation and in a detachable manner, the spring elements are arranged as annular springs, bolts attached to the magnet body protrude through recesses in the armature disk, and the spring elements supported on the magnet body press onto the armature disk so that when the winding is supplied with current, the armature disk is pulled towards the magnet body against a spring force generated by the spring elements and the brake-lining carrier is moved away from the friction surface via the second force component and so that when the winding is not supplied with current, the spring elements press the armature disk towards the brake-lining carrier, thus pressing the brake-lining carrier against the friction surface.

35. The brake assembly according to claim 16, wherein a diameter of a round wire of the spring part is larger than a smallest groove width of the annular groove measured in the axial direction.

36. An electric motor, comprising:
the brake arrangement recited in claim 16;
wherein the shaft is arranged as a rotor shaft of the electric motor.
